(19) United States
(12) Patent Application Publication
(10) Pub. No.: US 2013/0003083 A1
(43) Pub. Date: Jan. 3, 2013

(54) Image Processing Apparatus and Image Forming Apparatus

(75) Inventor: Seiki Satomi, Osaka (JP)

(73) Assignee: Kyocera Document Solutions, Inc.

(21) Appl. No.: 13/526,908

(22) Filed: Jun. 19, 2012

(30) Foreign Application Priority Data
Jun. 28, 2011 (JP) 2011-142443

(51) Int. Cl. G06K 15/02

(52) U.S. Cl. 358/1.2

(57) ABSTRACT

An image processing apparatus of this disclosure includes: a characteristic detecting unit configured to detect a pixel which has a dot in a thin line with one-dot width in an original binary image; an enlargement processing unit configured to identify a pixel area which corresponds to the pixel in a binary image obtained by converting resolution of the original binary image; and a pattern processing unit configured to delete at least one dot in the identified pixel area, if the number of pixels in width of the identified pixel area is larger in a vertical direction to the enlarged thin line than the number of pixels in width of another pixel area in the enlarged thin line.

### CROSS-REFERENCE TO RELATED APPLICATION

This application relates to and claims priority rights from a Japanese Patent Application: No. 2011-142443, filed on Jun. 28, 2011, the entire disclosures of which are hereby incorporated by reference herein.

### BACKGROUND OF THE INVENTION

1. Field of the Invention

The present invention relates to image processing apparatuses and image forming apparatuses.

2. Description of the Related Art

When a binary image is enlarged with non-integral multiplication using the nearest neighbor method, the enlarged binary image often contains a cyclic pattern which is not contained originally.

For example, in an enlargement process with non-integral multiplication from 1 time to 2 times, an oblique thin line with one-dot width in an image is converted to lines with one-dot width and lines with two-dot width which are located cyclically in the enlarged image. Especially, if the oblique thin line has an angle near to the vertical or the horizontal, such cyclic pattern appears strongly. It should be noted that the enlargement of an image is the same meaning as increasing image resolution.

FIGS. 7A and 7B show an example of the cyclic pattern in the enlarged image when the resolution is multiplied by 1.5. FIG. 7A shows an image before the enlargement, and FIG. 7B shows an image obtained by enlarging the image shown in FIG. 7A. In the image before the enlargement, an oblique thin line is formed by slantingly putting horizontal thin lines with one-dot width. If the image shown in FIG. 7A is multiplied by 1.5 using the nearest neighbor method, then lines with one-dot width and lines with two-dot width appear alternately as shown in FIG. 7B.

In order to solve such problem, are proposed some techniques which a thin line is converted to an enlarged line with a constant width. One technique performs a projection process and then performs a thinning process of a line for stabilizing the line width. Another technique calculates a density of a position between pixels as an interpolated value by a linear interpolation, integrates the interpolated values in a pixel in an enlarged image, and determines whether the pixel has a dot or not by comparing the integrated value with a threshold value.

The aforementioned techniques require a lot of calculation although a constant width of a line in an enlarged image is obtained. Therefore, a low performance machine takes a lot of time for the enlargement process.

Further, if an image is enlarged for printing, thin lines in the enlarged image are favorable against dot gain in printing.

### SUMMARY OF THE INVENTION

An image processing apparatus according to an aspect of this disclosure includes: a characteristic detecting unit configured to detect a pixel which has a dot in a thin line with one-dot width in an original binary image; an enlargement processing unit configured to identify a pixel area which corresponds to the pixel in a binary image obtained by converting resolution of the original binary image; and a pattern processing unit configured to delete at least one dot in the identified pixel area, if the number of pixels in width of the identified pixel area is larger in a vertical direction to the enlarged thin line than the number of pixels in width of another pixel area in the enlarged thin line.

An image forming apparatus according to an aspect of this disclosure includes the aforementioned image processing apparatus to increase image resolution.

Therefore, according to a shape of a pixel area, it easily determines whether at least one dot should be deleted in the pixel area. Consequently, the inconstancy of a line width due to enlargement of a binary image is weakened and the image quality is gained with low calculation complexity.

These and other objects, features and advantages of the present invention will become more apparent upon reading of the following detailed description along with the accompanied drawings.

### BRIEF DESCRIPTION OF THE DRAWINGS

FIG. 1 shows a block diagram which indicates a configuration of an image forming apparatus in Embodiment 1 of the present disclosure;

FIG. 2 shows a flowchart which explains an operation of the image processing apparatus shown in FIG. 1;

FIGS. 3A to 3C show diagrams which explain an enlargement process of 1.5 times by the image processing apparatus in Embodiment 1;

FIG. 4 shows a diagram which indicates a relationship between a shape of a pixel area obtained by enlargement and necessity of a pattern process in Embodiment 1;

FIGS. 5A and 5B show diagrams which explain an enlargement process of 1.5 times by the image processing apparatus in Embodiment 2;

FIGS. 6A and 6B show diagrams which explain an enlargement process of 2.5 times by the image processing apparatus in Embodiment 2; and

FIGS. 7A and 7B show an example of a cyclic pattern in an enlarged image when image resolution is multiplied by 1.5.

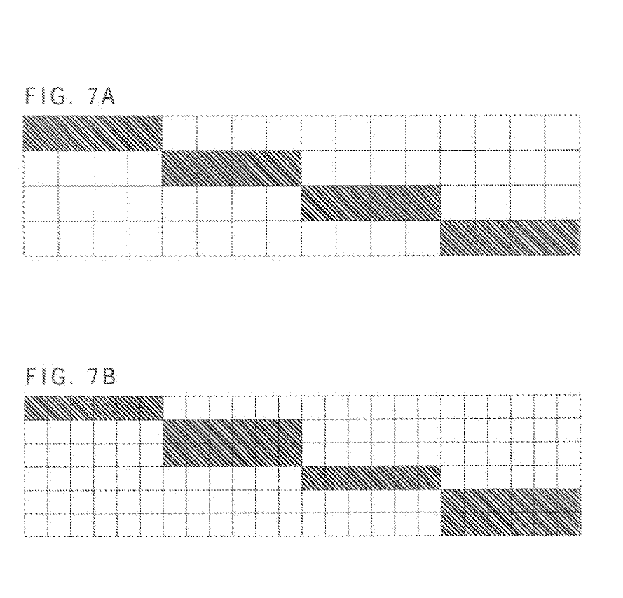

### DETAILED DESCRIPTION

Hereinafter, embodiments according to aspects of the present disclosure will be explained with reference to drawings.

### Embodiment 1

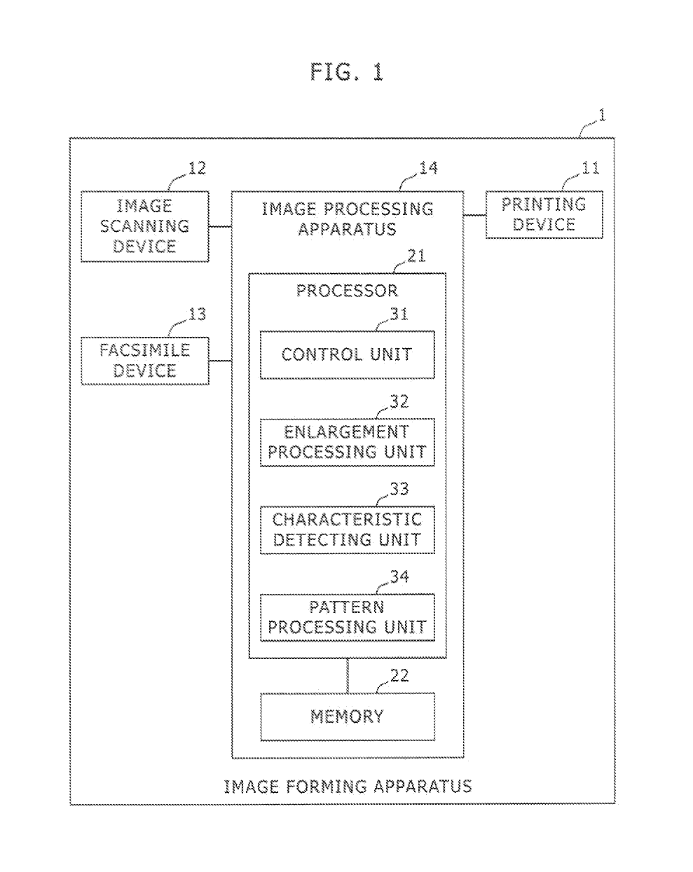

FIG. 1 shows a block diagram which indicates a configuration of an image forming apparatus 1 in Embodiment 1 of the present disclosure. The image forming apparatus 1 shown in FIG. 1 is a multi-function peripheral. Alternatively, the image forming apparatus 1 may be a printer, a copier, or a facsimile machine.

This image forming apparatus 1 includes a printing device 11, an image scanning device 12, a facsimile device 13, and an image processing apparatus 14.

The printing device 11 is an internal device which prints a document image based on raster image data. For example, the printing device 11 prints a document image based on image data to which the image processing apparatus 14 has applied an enlargement process.

The image scanning device 12 is an internal device which optically scans a document image from a document, and generates image data of the document image.

The facsimile device 13 is an internal device which generates a facsimile signal from image data of a document image to be transmitted and transmits the facsimile signal, and receives a facsimile signal and converts it to image data.

The image processing apparatus 14 performs image processing such as an enlargement process for image data generated by the image scanning device 12, the facsimile device 13 and so forth. In this embodiment, the image processing apparatus 14 enlarges an original binary image with non-integral multiplication in a vertical direction and/or a horizontal direction. For instance, the image processing apparatus 14 converts resolution of an original binary image received and generated by the facsimile device 13 from 400 dpi (dot per inch) to 600 dpi for printing. This is non-integral multiplication, i.e. 1.5 times enlargement.

The image processing apparatus 14 includes a processor 21 and a memory 22. The processor 21 includes an ASIC (Application Specific Integrated Circuit) and/or a micro computer, and forms processing units. The memory 22 is a rewritable memory device such as RAM (Random Access Memory). In the memory 22, temporarily stored are image data before image processing such as the enlargement process, image data in the middle of the image processing, image data after the image processing, and so forth.

The processor 21 forms a control unit 31, an enlargement processing unit 32, a characteristic detecting unit 33, and a pattern processing unit 34 as the processing units.

The control unit 31 scans pixels in turn along the primary scanning direction and the secondary scanning direction in image data of an original binary image before the enlargement process (i.e. before converting image resolution), and detects a pixel having a dot (i.e. a pixel with the pixel value “1”) as a target pixel.

In the enlargement process, the enlargement processing unit 32 identifies a pixel area which corresponds to the target pixel in a binary image obtained by converting resolution of the original binary image. In Embodiment 1, the enlargement processing unit 32 identifies the pixel area using the nearest neighbor method.

The characteristic detecting unit 33 detects a pixel which has a dot in a thin line in the original binary image. Specifically, the characteristic detecting unit 33 obtains values of pixels adjacent to the target pixel, and on the basis of these values of the adjacent pixel, determines whether the target pixel has a dot which is included by a thin line or not.

In Embodiment 1, the thin line is either a vertical line with one-dot width or a horizontal line with one-dot width, and dots on edges the thin line shall be included by the thin line. Here, the horizontal line is a set of dots located continuously and straightly along the primary scanning direction, and the vertical line is a set of dots located continuously and straightly along the secondary scanning direction.

The pattern processing unit 34 deletes at least one dot in the pixel area identified by the enlargement processing unit 32, if the number of pixels in width of the identified pixel area is larger in a vertical direction to the enlarged thin line than the number of pixels in width of another pixel area in the enlarged thin line.

In this embodiment, the pattern processing unit 34 deletes at least one dot in the identified pixel area so as to make the number of dots in width in the vertical direction of the identified pixel area equal to the number of pixels in width of the another pixel area.

In this embodiment, the pattern processing unit 34 chooses dots to be deleted in the identified pixel area so as not to locate these dots continuously in either a vertical direction or a horizontal direction.

In the following part, explained is an operation of the image forming apparatus in Embodiment 1.

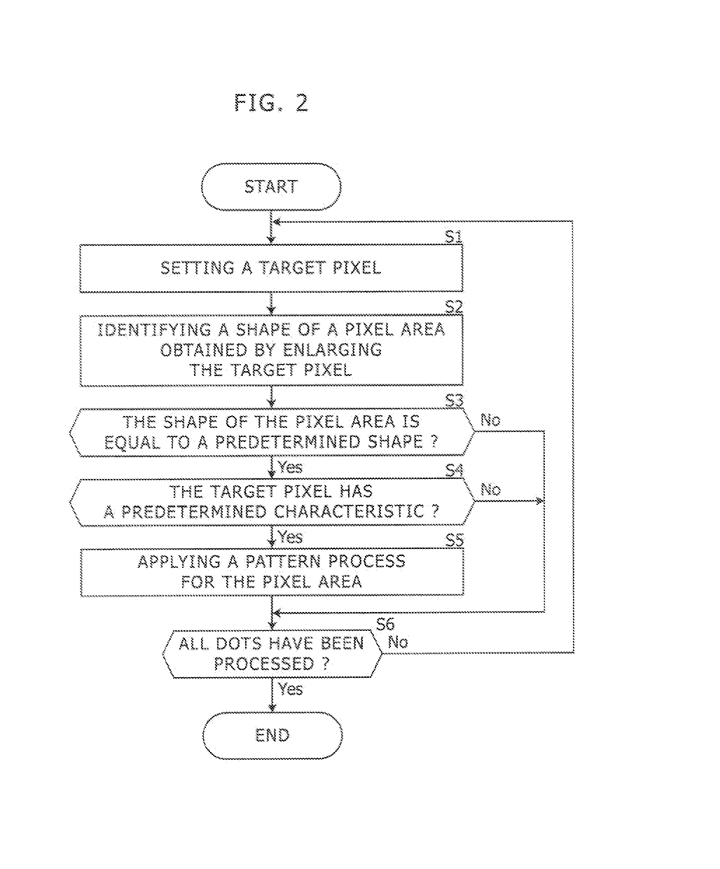

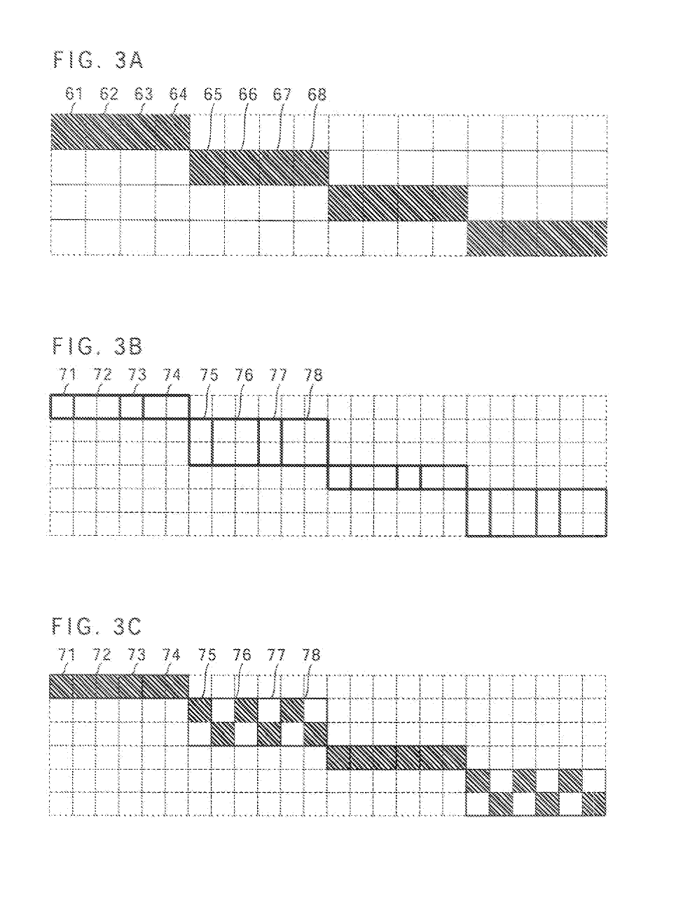

FIG. 2 shows a flowchart which explains an operation of the image processing apparatus 14 shown in FIG. 1. FIGS. 3A to 3C show diagrams which explain an enlargement process of 1.5 times by the image processing apparatus 14 in Embodiment 1.

Firstly, image data of a binary image is stored into the memory 22, and the enlargement process of non-integral multiplication is applied to the image data. A memory area is allocated for image data obtained through the enlargement process (i.e. image data of an enlarged image), and all pixel values in the image data are initially set as the value (here, zero) which indicates that the pixel does not have a dot.

Upon receiving a request of the enlargement process, for example, from a user, the control unit 31 reads out the image data, checks pixel values in the image data in turn along the primary scanning direction and the secondary scanning direction, and when detecting a pixel which has a dot, sets the detected pixel as a target pixel (Step S1).

After finishing the following process for the current target pixel, the control unit 31 restarts to check pixel values from a pixel next to the current target pixel in the image data in turn along the primary scanning direction and the secondary scanning direction, and when detecting a pixel which has a dot, sets the detected pixel as a next target pixel.

The enlargement processing unit 32 identifies a pixel area which corresponds to the target pixel in the enlarged image (Step S2). The enlargement processing unit 32 identifies the pixel area in the enlarged image using the nearest neighbor method. The pixel area consists of one or more pixels corresponding to the target pixel. The enlargement processing unit 32 sets a value of each pixel in the identified pixel area as the value (here, “1”) which indicates that the pixel has a dot.

For instance, in a case that a binary image shown in FIG. 3A is enlarged, pixel areas 71 and 73 in FIG. 3B correspond to pixels 61 and 63 in FIG. 3A. Each of the pixel areas 71 and 73 is an area of which the horizontal and the vertical lengths are 1 pixel. Further, pixel areas 72 and 74 correspond to pixels 62 and 64. Each of the pixel areas and 74 is an area of which the horizontal length is 2 pixels and the vertical length is 1 pixel. Furthermore, pixel areas 75 and 77 correspond to pixels 65 and 67. Each of the pixel areas 75 and 77 is an area of which the horizontal length is 1 pixel and the vertical length is 2 pixels. Furthermore, pixel areas 76 and 78 correspond to pixels 66 and 68. Each of the pixel areas 76 and 78 is an area of which the horizontal and the vertical lengths are 2 pixels.

Therefore, each of the pixel areas 71 to 78 which correspond to the pixels 61 to 68 which are included by a horizontal thin line with one-dot width has any of the aforementioned four shapes.

The enlargement processing unit 32 determines whether in the pixel area which corresponds to the target pixel, the number of pixels in width in the vertical direction to the thin line is larger than the number of pixels in width of any of the other pixel areas (Step S3).

For instance, in the case shown in FIG. 3B, it is determined that in each of the pixel areas 75 to 78, the number of pixels in width in the vertical direction to the horizontal thin line (i.e. the vertical direction of the image) (here, “2”) is larger than the number of pixels in width of any of the pixel areas 71 to 74 (here, “1”). Contrary to this, it is not determined that in each of the pixel areas 71 to 74, the number of pixels in width in the vertical direction to the horizontal thin line (i.e. the vertical direction of the image) is larger than the number of pixels in width of any other pixel areas.

If it is determined that in the pixel area which corresponds to the target pixel, the number of pixels in width in the vertical direction to the horizontal thin line is larger than the number of pixels in width of any other pixel areas, then the characteristic detecting unit 33 reads out values of pixels adjacent to the target pixel from the image data, and determines whether the target pixel has a dot which is included by a thin line (Step S4).

In an area of which the center is the target pixel and the vertical and the horizontal lengths are 3 pixels, if all of the target pixel and two pixels horizontally adjacent to the target pixel have dots and the other pixels in the area do not have any dots, then it is determined that the target pixel is included by a horizontal thin line; and if all of the target pixel and two pixels vertically adjacent to the target pixel have dots and the other pixels in the area do not have any dots, then it is determined that the target pixel is included by a vertical thin line.

Further, in an area of which the center is the target pixel and the vertical and the horizontal lengths are 3 pixels, if both of the target pixel and only one of two pixels horizontally adjacent to the target pixel have dots and the other pixels in the area do not have any dots, then it is determined that the target pixel has a dot on an edge of a horizontal thin line; and if both of the target pixel and only one of two pixels vertically adjacent to the target pixel have dots and the other pixels in the area do not have any dots, then it is determined that the target pixel has a dot on an edge of a vertical thin line. In FIG. 3A, the pixel 61, the pixel 64, the pixel 65, and the pixel 68 are determined as the pixels on edges of horizontal thin lines.

In Embodiment 1, a dot on an edge of a horizontal thin line shall be included by the horizontal thin line, and a dot on an edge of a vertical thin line shall be included by the vertical thin line.

If the target pixel has a dot which is included by a vertical or horizontal thin line, then the pattern processing unit 34 performs a pattern process for the pixel area which corresponds to the target pixel. In this pattern process, the pattern processing unit 34 deletes at least one dot in the pixel area in the enlarged image. Specifically, the pattern processing unit 34 changes a value of a pixel to be deleted in the pixel area to the value which indicates that the pixel does not have a dot (here, zero).

On the other hand, either if in Step S3 it is not determined that in the pixel area which corresponds to the target pixel, the number of pixels in width in the vertical direction to the horizontal thin line is larger than the number of pixels in width of any other pixel areas or if in Step S4 it is not determined that the target pixel has a dot which is included by a vertical or horizontal thin line, then the pattern processing unit 34 does not perform the pattern process (i.e. dot deletion) for the pixel area which corresponds to the target pixel.

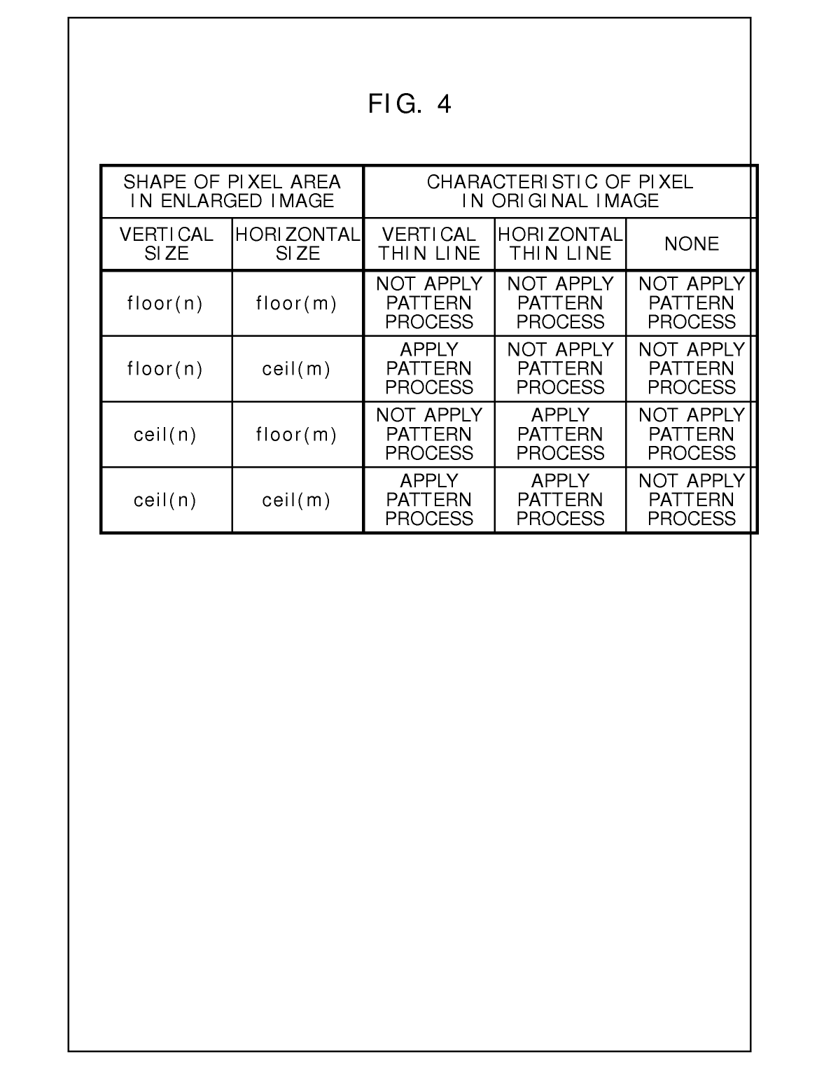

FIG. 4 shows a diagram which indicates a relationship between a shape of a pixel area obtained by enlargement and necessity of a pattern process in Embodiment 1. As shown in FIG. 4, a shape of the pixel area in the enlarged image is any of the aforementioned four shapes, and the numbers of pixels in the vertical and horizontal lengths of the pixel area can be expressed with the vertical magnification n, the horizontal magnification m, the floor function, and the ceil function. The floor function is a function which returns an integer value obtained by rounding down an argument of this function. The ceil function is a function which returns an integer value obtained by rounding up an argument of this function. If the argument is larger than 1 and less than 2, then the floor function returns 1, and the ceil function returns 2.

For instance, in the case shown in FIGS. 3A to 3C, if the pixel area which corresponds to the target pixel is any of the pixel areas 75 to 78 in FIG. 3C (namely, if the number of pixels of this pixel area in the vertical direction to the horizontal thin line is larger than the number of pixels of another pixel area in the vertical direction), then at least one dot is deleted in this pixel area. Contrary to this, if the pixel area which corresponds to the target pixel is any of the pixel areas 71 to 74 in FIG. 3C (namely, if the number of pixels of this pixel area in the vertical direction to the horizontal thin line is not larger than the number of pixels of any other pixel areas in the vertical direction), then no dots are deleted in this pixel area, and each pixel in this pixel area has a dot.

In Embodiment 1, for example, on the basis of values of pixels adjacent to the pixel area, the pattern processing unit 34 chooses a pixel of which a dot is deleted. For instance, in the case shown in FIGS. 3A to 3C, in the pixel area 75, the pattern processing unit 34 does not delete a dot of a pixel near to the pixel area 74 of which the number of pixels in the vertical direction is smaller than the pixel area 75, and deletes a dot of another pixel. Further, such as the pixel areas 75 to 78, if pixel areas in which dots should be deleted are located continuously, then the pattern processing unit 34 chooses pixels of which dots to be deleted so as not to locate these pixels continuously in either a vertical direction or a horizontal direction.

After the process of Steps S2 to S5 for the current target pixel, the control unit 31 restarts to check pixel values from a pixel next to the current target pixel in the image data in turn along the primary scanning direction and the secondary scanning direction, and when detecting a pixel which has a dot, sets the detected pixel as a next target pixel, and causes to perform the process of Steps S2 to S5 for the next target pixel (Step S6). If a next pixel which has a dot is not detected in the image data, then the control unit 31 determines that all dots have been processed, and terminates the enlarge process.

In the aforementioned Embodiment 1, the characteristic detecting unit 33 detects a pixel which has a dot included by a thin line in an original binary image before converting resolution (i.e. before the enlargement process); the enlargement processing unit 32 identifies a pixel area which corresponds to the target pixel in a binary image obtained by converting resolution of the original binary image; and the pattern processing unit 34 deletes at least one dot in the pixel area identified by the enlargement processing unit 32, if the number of pixels in width of the identified pixel area is larger in a vertical direction to the enlarged thin line than the number of pixels in width of another pixel area in the enlarged thin line.

Therefore, according to a shape of a pixel area, it easily determines whether at least one dot should be deleted in the pixel area. Consequently, the inconstancy of a line width due to enlargement of a binary image is weakened and the image quality is gained with low calculation complexity.

### Embodiment 2

An image forming apparatus in Embodiment 2 of the present disclosure has the basic configuration same as that in Embodiment 1. However, the behavior of the pattern processing unit 34 in Embodiment 2 is not the same as that in Embodiment 1.

In Embodiment 2, if the identified pixel area corresponds to a pixel other than pixels which have dots on edges of the thin line, then the pattern processing unit 34 deletes at least one dot in the identified pixel area. However, if the identified pixel area corresponds to any of the pixels which have dots on edges of the thin line, then the pattern processing unit 34 does not delete any dots in the identified pixel area.

Further, in Embodiment 2, the pattern processing unit 34 chooses at least one dot to be deleted in consideration with a coordinate value of a pixel which has the dot to be deleted.

In the following part, explained is an operation of the image forming apparatus in Embodiment 2.

In Embodiment 2, the characteristic detecting unit 33 considers dots on edges of a horizontal thin line not to be included by the horizontal thin line, and considers dots on edges of a vertical thin line not to be included by the vertical thin line. It is determined whether the target pixel has a dot on an edge of a thin line or not as well as Embodiment 1.

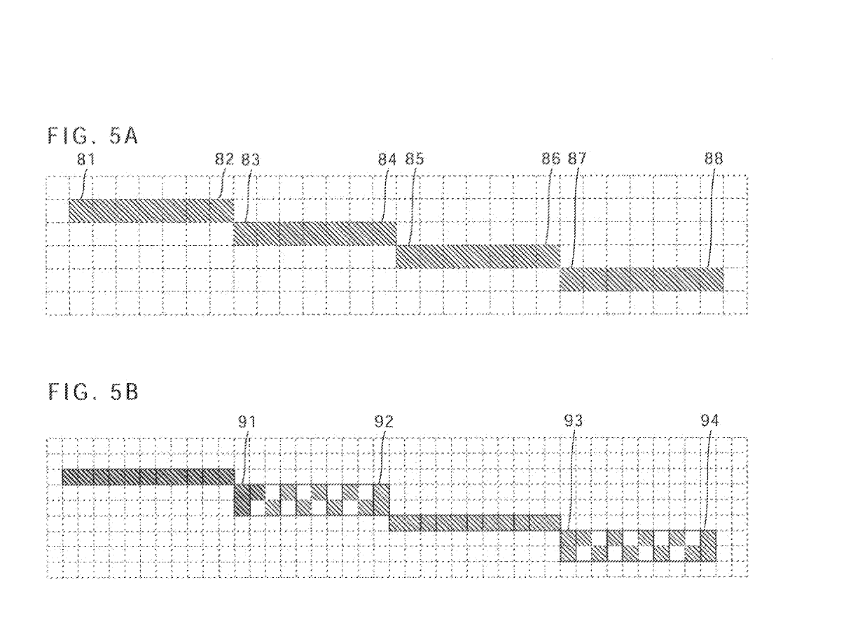

FIGS. 5A and 5B show diagrams which explain an enlargement process of 1.5 times by the image processing apparatus in Embodiment 2.

For instance, an image shown in FIG. 5B is obtained by performing the enlargement process for an image shown in FIG. 5A. In FIG. 5A, pixels 81 to 88 are detected as pixels which have dots on edges of horizontal thin lines. The pattern process (i.e. dot deletion) is not performed for pixel areas 91, 92, 93, and 94 which correspond to the pixels 83, 84, 87, and 88 among the detected pixels.

Further, in Embodiment 2, at least one dot to be deleted is chosen in consideration with a coordinate value of a pixel which has the dot to be deleted. The coordinate value indicates the position of the pixel on two coordinate axes along the primary scanning direction and the secondary scanning direction. Assuming that the X coordinate axis is set along the primary scanning direction and the Y coordinate axis is set along the secondary scanning direction, for the pixel area in which at least one dot should be deleted, the pattern processing unit 34 calculates the remainder Xmod by dividing a X coordinate value by 2 (i.e. dividing by the number of pixels in width) and the remainder Ymod by dividing a Y coordinate value by 2 (i.e. dividing by the number of pixels in width), and deletes a dot of a pixel if one of the remainders Xmod and Ymod of the pixel is zero and the other is 1. Consequently, the number of dots in width of the pixel areas with a large width is set to be equal to the number of dots in width of the pixel areas with a small width. In FIG. 5B, the number of dots in width of the pixel areas in which the number of pixel in width is 2 is set to be 1.

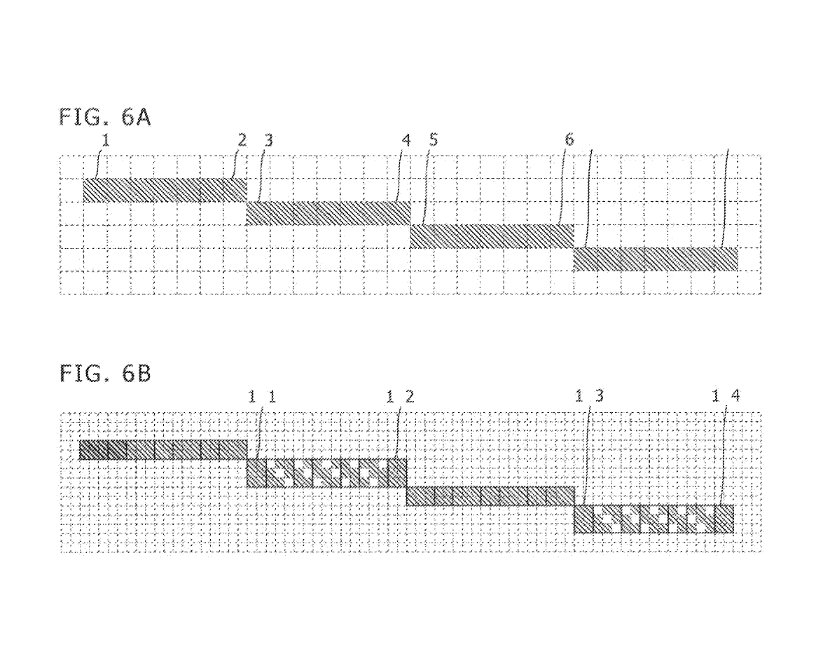

FIGS. 6A and 6B show diagrams which explain an enlargement process of 2.5 times by the image processing apparatus in Embodiment 2.

For instance, an image shown in FIG. 6B is obtained by performing the enlargement process for an image shown in FIG. 6A. In FIG. 6A, pixels 81 to 88 are detected as pixels which have dots on edges of horizontal thin lines. The pattern process (i.e. dot deletion) is not performed for pixel areas 101, 102, 103, and 104 which correspond to the pixels 83, 84, 87, and 88 among the detected pixels.

In the case shown in FIGS. 6A and 6B, for the pixel area in which at least one dot should be deleted, the pattern processing unit 34 calculates the remainder Xmod by dividing a X coordinate value by 3 (i.e. dividing by the number of pixels in width) and the remainder Ymod by dividing a Y coordinate value by 3 (i.e. dividing by the number of pixels in width), and deletes a dot of a pixel if the remainder Xmod of the pixel is equal to the remainder Ymod of the pixel. Consequently, the number of dots in width of the pixel areas with a large width is set to be equal to the number of dots in width of the pixel areas with a small width. In FIG. 6B, the number of dots in width of the pixel areas in which the number of pixel in width is 3 is set to be 2.

In the aforementioned Embodiment 2, if the identified pixel area corresponds to a pixel other than pixels which have dots on edges of the thin line, then the pattern processing unit 34 deletes at least one dot in the identified pixel area. However, if the identified pixel area corresponds to any of the pixels which have dots on edges of the thin line, then the pattern processing unit 34 does not delete any dots in the identified pixel area. Therefore, since a dot on the line edge is not deleted, a large gap does not appear between the lines, and the image quality of the enlarged image is gained.

Further, in Embodiment 2, the pattern processing unit 34 chooses at least one dot to be deleted in consideration with a coordinate value of a pixel which has the dot to be deleted. Therefore, it is possible to choose a dot to be deleted without a complex calculation.

The description of the present invention has been presented for purposes of illustration and description, and is not intended to be exhaustive or limited to the invention in the form disclosed.

For example, in any of the aforementioned embodiments, the vertical magnification may not be equal to the horizontal magnification in the enlargement process. Further, in any of the aforementioned embodiments, the original binary image may be enlarged in only one of the vertical direction and the horizontal direction.

Furthermore, in any of the aforementioned embodiments, if the vertical magnification n is equal to the horizontal magnification m, then the pattern processing unit 34 deletes at least one dot so that the ratio of the number of dots and the number of pixels in the pixel area after the pattern process is equal to floor (n):ceil (n).

In any of the aforementioned embodiments, if the vertical magnification n is not equal to the horizontal magnification m, then according to the relationship shown in FIG. 4, as well as the aforementioned case, the pattern processing unit 34 identifies a pixel area for which the pattern process is performed. In addition, if the target pixel has a dot which is included by a horizontal thin line, then the pattern processing unit 34 deletes at least one dot so that the ratio of the number of dots and the number of pixels in the pixel area after the pattern process is equal to floor (n):ceil (n). If the target pixel has a dot which is included by a vertical thin line, then the pattern processing unit 34 deletes at least one dot so that the ratio of the number of dots and the number of pixels in the pixel area after the pattern process is equal to floor (m):ceil (m).

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

What is claimed is:

1. An image processing apparatus configured to enlarge a binary image which includes a thin line with one-dot width by converting resolution of the binary image, comprising:
a characteristic detecting unit configured to detect a pixel which has a dot in a thin line with one-dot width in an original binary image;
an enlargement processing unit configured to identify a pixel area which corresponds to the pixel in a binary image obtained by converting resolution of the original binary image; and
a pattern processing unit configured to delete at least one dot in the identified pixel area, if the number of pixels in width of the identified pixel area is larger in a vertical direction to the enlarged thin line than the number of pixels in width of another pixel area in the enlarged thin line.

2. The image processing apparatus according to claim 1, wherein:
the pattern processing unit is further configured to delete at least one dot in the identified pixel area so as to make the number of dots in the vertical direction in the identified pixel area equal to the number of pixels in width of the another pixel area.

3. The image processing apparatus according to claim 1, wherein:
the pattern processing unit is further configured to delete at least one dot in the identified pixel area if the identified pixel area corresponds to a pixel other than pixels which have dots on edges of the thin line, and not delete a dot in the identified pixel area if the identified pixel area corresponds to any of the pixels which have dots on edges of the thin line.

4. The image processing apparatus according to claim 1, wherein:
the pattern processing unit is further configured to choose at least one dot to be deleted in consideration with a coordinate value of a pixel which has the dot to be deleted.

5. The image processing apparatus according to claim 1, wherein:
the pattern processing unit is further configured to choose dots to be deleted in the identified pixel area so as not to locate the dots to be deleted continuously in either a vertical direction or a horizontal direction.

6. The image processing apparatus according to claim 1, wherein:
the enlargement processing unit is further configured to identify the pixel area in the binary image obtained by enlarging the original binary image with non-integral multiplication in a vertical direction and/or a horizontal direction.

7. The image processing apparatus according to claim 1, wherein:
the enlargement processing unit is further configured to identify the pixel area using the nearest neighbor method.

8. An image forming apparatus, comprising:
an image processing apparatus configured to enlarge a binary image which includes a thin line with one-dot width by converting resolution of the binary image; and
a printing device configured to print a binary image which the image processing apparatus generates by converting resolution of the binary image;
wherein the image processing apparatus comprises:
a characteristic detecting unit configured to detect a pixel which has a dot in a thin line with one-dot width in an original binary image;
an enlargement processing unit configured to identify a pixel area which corresponds to the pixel in a binary image obtained by converting resolution of the original binary image; and
a pattern processing unit configured to delete at least one dot in the identified pixel area, if the number of pixels in width of the identified pixel area is larger in a vertical direction to the enlarged thin line than the number of pixels in width of another pixel area in the enlarged thin line.
